(19) United States
(12) Patent Application Publication
(10) Pub. No.: US 2020/0211127 A1
(43) Pub. Date: Jul. 2, 2020

(54) Methods and Systems for Performing Decision Scenario Analysis

(71) Applicant: ExxonMobil Upstream Research Company, Spring, TX (US)

(72) Inventors: Xiaohui Wu, Sugar Land, TX (US); Thomas C. Halsey, Houston, TX (US); Mary Ellen Meurer, Magnolia, TX (US); Dennis R. O'Brien, The Woodlands, TX (US)

(21) Appl. No.: 16/722,262

(22) Filed: Dec. 20, 2019

Related U.S. Application Data
(60) Provisional application No. 62/786,858, filed on Dec. 31, 2018.

(51) Int. Cl. G06Q 50/02; G06F 16/2458; G06Q 10/06

(52) U.S. Cl. CPC G06Q 50/02; G06Q 10/0637; G06Q 10/0635; G06F 16/2462

(57) ABSTRACT

An example method can comprise defining a plurality of subsurface scenarios and discretizing a decision space to determine a plurality of distinct decision scenarios. The subsurface scenarios can be sparsely sampled to determine a candidate subset of the plurality of subsurface scenarios. Each of the candidate subset of the plurality of subsurface scenarios can be associated with a respective one of the plurality of distinct decision scenarios. Each of the plurality of distinct decision scenarios can be modelled based on each of the candidate subset of the plurality of subsurface scenarios to determine risk and reward values for each of the plurality of distinct decision scenarios.

### CROSS-REFERENCE TO RELATED APPLICATIONS

This application claims the benefit of U.S. Provisional Application No. 62/786,858 filed on Dec. 31, 2018, the disclosure of which is incorporated herein by reference.

### BACKGROUND

In the oil and gas industry, it is common to make business decisions, the performance/result of which will be determined by configuration of subsurface geological properties (e.g., permeability, porosity, flow barriers, flow conduits, phase behavior of subsurface oil and gas, and the like). Knowledge about the subsurface geological properties of any particular area is extremely limited. The subsurface properties can be partially determined by techniques such as seismic imaging, appraisal drilling, well testing, and the like. However, these techniques provide reliable information only in the neighborhood of the test location or at a resolution insufficient for supporting business decisions. Accordingly, companies involved in hydrocarbon operations are often making investment and/or operations decisions in the presence of deep uncertainty.

Depletion planning sets forth a framework for resource management and underpins efficient extraction of a resource. In particular, depletion planning can comprise determination of a drive mechanism and/or a drilling and completion strategy under given constraints of field development. Depletion planning can be a difficult problem. In particular, finding a robust depletion plan is challenging because of the large number of decision variables involved and the many plausible subsurface scenarios.

One solution is to develop a robust methodology for determining a depletion plan. One such methodology attempts to develop a space-filling sample set of subsurface scenarios, modeling each uncertain variable in the subsurface scenario to create a large ensemble of realizations, and simulating the ensemble of realizations to identify flow scenarios. However, the high-dimensional subsurface uncertainty space can require a very large number of realizations (e.g., on the order of tens of thousands to millions) to adequately reflect the uncertainty of the geological subsurface properties. Thus, the modeling and simulation require substantial time and computational cost.

Another potential solution is to develop a heuristic-based framework based on the known uncertainties in the subsurface and select a representative group of scenarios for detailed analysis. However, selection of the representative group relies on judgment and may not cover the range of possible outcomes, or may cover the range poorly. Accordingly, the selection can underestimate risks associated with the various scenarios. Moreover, the judgments used to select the representative group are often unreliable and could be subject to cognitive and motivational biases.

These and other shortcomings are addressed in the present application.

### SUMMARY

It is to be understood that both the following general description and the following detailed description are exemplary and explanatory only and are not restrictive. Provided are methods and systems for scenario-based analysis of oil and/or gas fields.

In a first aspect, an example method can comprise defining a plurality of subsurface scenarios and discretizing a decision space to determine a plurality of distinct decision scenarios. The subsurface scenarios can be sparsely sampled to determine a candidate subset of the plurality of subsurface scenarios. Each of the candidate subset of the plurality of subsurface scenarios can be associated with a respective one of the plurality of distinct decision scenarios. Each of the plurality of distinct decision scenarios can be modelled based on each of the candidate subset of the plurality of subsurface scenarios to determine risk and reward values for each of the plurality of distinct decision scenarios.

In a second aspect, an apparatus can comprise one or more processors and a memory having embodied thereon processor executable instructions that, when executed by the one or more processors, cause the apparatus to define a plurality of subsurface scenarios. The instructions can further cause the apparatus to discretize a decision space to determine a plurality of distinct decision scenarios and sparsely sample the subsurface scenarios to determine a candidate subset of the plurality of subsurface scenarios. The apparatus can associate each of the candidate subset of the plurality of subsurface scenarios with a respective one of the plurality of distinct decision scenarios, and model each of the plurality of distinct decision scenarios based on each of the candidate subset of the plurality of subsurface scenarios to determine risk and reward values for each of the plurality of distinct decision scenarios.

In a third aspect, an apparatus can comprise a subsurface scenario generator configured to define a plurality of subsurface scenarios and a decision scenario discretizer configured to discretize a decision space to determine a plurality of distinct decision scenarios. The apparatus can further comprise a search processor configured to sparsely sample the subsurface scenarios to determine a candidate subset of the plurality of subsurface scenarios and associate each of the candidate subset of the plurality of subsurface scenarios with a respective one of the plurality of distinct decision scenarios. A modeler can be configured to model each of the plurality of distinct decision scenarios based on each of the candidate subset of the plurality of subsurface scenarios to determine risk and reward values for each of the plurality of distinct decision scenarios.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an example system for performing decision scenario analysis for hydrocarbon operations, such as for oil field development;

FIG. 2 illustrates sample dependencies of a set of geological and physical parameters of the subsurface;

FIG. 3 shows an example decision space;

FIG. 4 is a flowchart of an example method; and

FIG. 5 is an example of a decision model.

### NOMENCLATURE

Various terms as used herein are defined below and throughout the specification. To the extent a term used in the claims is not defined below, it should be given the broadest definition persons in the pertinent art have given that term as reflected in at least one printed publication or issued patent.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models, and determining the likely locations for hydrocarbon reservoirs within the subsurface. The measurement data may include seismic data, gravity data, magnetic data, electromagnetic data, and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of data to identify preferred development approaches and methods. By way of example, hydrocarbon development may include modeling of the subsurface formation and extraction planning for periods of production; determining and planning equipment to be utilized and techniques to be utilized in extracting the hydrocarbons from the subsurface formation; and the like.

As used herein, “hydrocarbon operations” refers to any activity associated with hydrocarbon exploration, hydrocarbon development, and/or hydrocarbon production.

As used herein, “hydrocarbon production” refers to any activity associated with extracting hydrocarbons from subsurface location, such as a well or other opening. Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

As used herein, “subsurface model” refers to a reservoir model, geomechanical model, and/or a geologic model. The subsurface model may include subsurface data distributed within the model in two-dimensions (e.g., distributed into a plurality of cells, such as elements or blocks), three-dimensions (e.g., distributed into a plurality of voxels), or four or more dimensions.

As used herein, “geologic model” is a model (e.g., three-dimensional model) of the subsurface region having static properties and includes objects, such as faults and/or horizons, and properties, such as facies, lithology, porosity, permeability, or the proportion of sand and shale.

As used herein, “reservoir model” is a model (e.g., three-dimensional model) of the subsurface that in addition to static properties, such as porosity and permeability, also has dynamic properties that vary over the timescale of resource extraction, such as fluid composition, pressure, and relative permeability.

As used herein, “geomechanical model” is a model (e.g., three-dimensional model) of the subsurface that contain static properties, such as rock compressibility and Poisson's ratio, and model the mechanical response (e.g. compaction, subsidence, surface heaving, faulting, and seismic event) of the rock to fluid injection and extraction.

As used herein, a “subsurface narrative” is the description of a class of genetically related subsurface organization of rock and fluid properties. Different subsurface narratives describe subsurface organizations with qualitative differences.

As used herein, “subsurface scenario” is a concept or partial subsurface model in combination with select parameters and their ranges used to build realizations of subsurface models by deterministically or stochastically varying these parameters. A subsurface scenario is derived from a subsurface narrative. The set of all plausible subsurface scenarios forms the subsurface space.

As used herein, a “subsurface realization” is a subsurface model (e.g., a geologic model) with rock and fluid properties fully defined. It is created from a subsurface concept or scenario by assigning geometry and location to faults, horizons, and boundaries, and values to properties which may be utilized for computations and quantitative queries.

As used herein, “simulate” is the process of making a prediction related to the resource extraction based on the execution of a reservoir-simulator computer program on a processor, which computes composition, pressure, or movement fluid as function of time and space for a specified scenario of injection and production wells by solving a set of reservoir fluid flow equations.

As used herein, a “decision space” (in the context of development and depletion planning) is the set of all possible decisions that can be made to address a set of development and depletion questions or objectives. A decision may provide satisfactory outcomes for many subsurface scenarios.

As used herein, a “decision metric” is a quantitative value used to evaluate a decision. A decision metric may include any factor that would differentiate one decision from another, e.g., social-economic, aspects of execution/safety, etc. A decision metric may be represented by a continuous, integral, or categorical variable.

As used herein, a set of decisions are “equivalent” if they give rise to decision metrics that fall into the same pre-defined metric value ranges (for continuous/integral metrics) or subsets (for categorical metrics). The set of equivalent decisions form a “decision class”, and the decision class may be used to structure fit-for-purpose decision granularity that changes with project stages, e.g., “go or no-go” decision in the early stage versus facility design and well planning decisions in later stages.

As used herein, a “decision scenario” is the combination of a decision, representing a decision class of equivalent decisions, and a “representative” subsurface model used to “communicate” to decision makers under what conditions the decision class is satisfactory in terms of the decision metrics.

The goal of “decision scenario analysis” is to explore competing “decision scenarios” and determine the best decision for given known subsurface uncertainties and communicate the decision using representative subsurface models.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems may be described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for performing decision scenario analysis for hydrocarbon operations, such as for oil field development. In particular, a method for developing a sparse sampling of uncertain subsurface scenarios to represent decision logics. For example, the decision logics can represent choices of facility, various well options, and/or the like. In some aspects, the facility choices and/or well options can be selected based on projected flow characteristics. The sparse sampling of the uncertain subsurface scenarios can be used to identify decision scenarios and associated sets of subsurface realizations. A robust candidate decision scenario can be selected from the set of decision scenarios. Plausible vulnerabilities and/or opportunities associated with the robust candidate decision scenario can be identified, and detailed subsurface realizations can be built based on the candidate decision scenario to further analyze the likelihood (e.g., probability of occurrence) of any identified vulnerabilities or opportunities.

First, one or more geological subsurface scenarios can be defined. A subsurface scenario can comprise a class of related subsurface organization of rock and fluid properties. Different subsurface scenarios describe subsurface organizations with differences beyond parametric variability. In some aspects, the subsurface scenarios involves selecting ranges of values for one or more of a plurality of unknown parameters related to the subsurface geology. For example, parameters can include structural properties, such as surface and fault properties (e.g., surface transmissibility, fault transmissibility, timing of faulting (e.g., pre-, syn-, or post-deposition)), and the like; stratigraphical and fluid properties, such as fluid contacts, fluid saturation, barriers and/or conduits to fluid flow (e.g., continuity among compartments), aquifer strength, and the like; lithofacies and saturation functions, such as environment of deposition, relative permeability, capillary pressure, and the like; rock properties such as porosity (ϕ), compressibility, hydraulic conductivity, and the like; and other similar parameters that can affect the decision scenario.

Particular subsurface realizations can be determined based on the defined one or more subsurface scenarios. For example, one or more subsurface realizations can be sampled by determining values for the parameters associated with the subsurface scenario. The one or more determined parameter value can be discrete or categorical values, continuous values, or a range of values. In some aspects, uncertainties associated with subsurface parameters can be considered when determining the parameter values.

In some aspects, the parameters can have values determined independently and at random. In other aspects, the values for at least one of the parameters can be determined in dependence on values selected for other parameters. In this way, the selection of the parameter values can maintain geologic plausibility.

A decision space can be defined. The decision space can be defined in terms of one or more hydrocarbon operation decisions to be made. For example, the decision space may be defined in terms of one or more hydrocarbon development or hydrocarbon production decisions to be made for the development and collection of the subsurface resources. For example, determinations regarding use of an offshore platform or floating production storage and offloading (FPSO) facility, facility capacity and capabilities, number of wells, well placement, sequence of drilling, and other decisions related to hydrocarbon development and hydrocarbon production operations. Other example determinations can comprise production ramp-up pace, depletion mechanism, well type, well design, wellhead pressures, drilling radius, well costs (e.g., drilling and completion costs, learning curve and market impacts, cost of rig mobilization and future rig moves, etc.), depletion mechanism (e.g., primary or pressure depletion, water injection or strong aquifer drive, gas cap or gas injection drive, etc.), incentives and requirements for phased depletion, drilling plan and schedule concerns such as drilling program execution, drilling duration, rig count, completion options, drilling center selection, drilling sequence, and the like. In this way, the decision space can be discretized such that there are a finite number of discrete scenarios in the decision space.

Subsurface realizations can be coupled to a particular decision from within the defined decision space. First, one of the subsurface scenarios can be selected, and a subsurface realization of that scenario can be sampled from the subsurface space. For the selected subsurface realization, an optimal decision can be selected from the decision space. A decision scenario associated with the selected optimal decision can be identified and recorded. This process can be repeated until a stopping criterion is satisfied. In some aspects, the stopping criterion can be related to the plurality of distinct decision scenarios. For example, the stopping criterion can comprise filling each of the finite number of discrete scenarios in the decision space. In other aspects, the stopping criteria can comprise a predetermined number of iterations without identifying a new distinct discrete scenario from the decision space, based on limitation of computing resource or time available to perform business analysis. When selecting a new subsurface realization, the selection can be made randomly (e.g., via a Monte Carlo method) or pseudorandomly, or can be selected based on a distance from one or more previously selected realizations. The distance can be calculated based on difference of sampled parameter vales from the values of existing realizations, or features such as reservoir connectivity, or based on simulations of fluid flow using the optimal decision associated with a previously selected subsurface realization, or based on simulation proxies such as physics-based graphical models or neural network models trained using simulations.

Once the stopping criteria has been met, the set of sample subsurface realizations may be defined. Optionally, a respective likelihood (e.g., probability of occurrence) of each of the sample subsurface scenarios being accurate can be determined. The respective likelihoods can be determined via known elicitation techniques, such as the Delphi method, or any other known technique for determining likelihoods.

Risk and reward values can be assigned to each of the sample decision scenarios. In some aspects, the risk and reward values can be determined by applying each decision scenario to all of the sampled subsurface realizations.

In some aspects, the risk and reward values can be used to select a particular depletion plan. For example, the risk and reward values can be used to cause one or more oil wells to be drilled at one or more corresponding particular locations. In some aspects, an average, for example a probability-weighted average, of the determined outputs under each plan can be used to determine the risk and reward values.

In some aspects, the risk and reward calculation may depend on the decision maker's risk attitude toward a specific decision. Risk attitude is the way an individual or a group responds to various uncertain outcomes. Broadly, risk attitudes can be classified into: risk-averse, risk-neutral, and risk-seeking. The difference between the three broad attitudes can be explained by the following example. If offered either $50 or 50% chance each of $100 and $0, a risk-neutral person would have no preference, while a risk-averse person would prefer the first offer (i.e., the $50) and a risk-seeking person would prefer the second offer (i.e., the 50% chance).

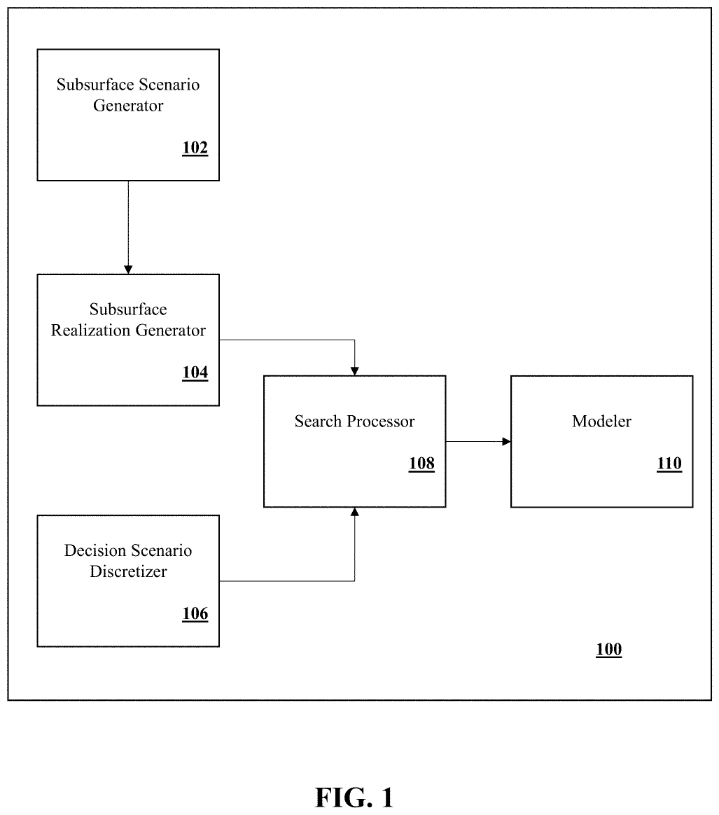

FIG. 1 is a block diagram illustrating various aspects of an exemplary system 100 in which the present method operates. While a functional description is provided, one skilled in the art will appreciate that the respective functions can be performed by software, hardware, or a combination of software and hardware.

In an aspect, the system 100 can comprise a subsurface scenario generator 102, a subsurface realization generator 104, a decision scenario discretizer 106, a search processor 108, and a modeler 110. The subsurface scenario generator 102 can define one or more geological subsurface scenarios. In particular, the subsurface scenario generator 102 can receive, as input, one or more unknown properties of the geological subsurface of an area of interest. The one or more properties can comprise structural properties, such as surface and fault properties (e.g., surface transmissibility, fault transmissibility, timing of faulting (e.g., pre-, syn-, or post-deposition)), and the like; stratigraphical and fluid properties, such as fluid contacts, fluid saturation, barriers and/or conduits to fluid flow (e.g., continuity among compartments), aquifer strength, and the like; lithofacies and saturation functions, such as environment of deposition, relative permeability, capillary pressure, and the like; rock properties such as porosity (ϕ), compressibility, hydraulic conductivity, and the like; and other similar parameters that can affect the decision scenario. The subsurface scenario generator 102 can define one or more subsurface scenarios by selecting one or more of the unknown properties of the subsurface geology on which to focus.

The subsurface realization generator 104 can determine a plurality of particular subsurface geological realizations. The subsurface geological realizations can be determined based on the defined one or more subsurface scenarios. One or more subsurface realizations can be determined by determining parameter values for the one or more properties identified in the subsurface scenario. In some aspects, the subsurface realization generator 104 can determine parameter values to be either a discrete value or a range of values. The determined parameter values can be selected such that the plurality of particular subsurface geological scenarios enable a broad sampling of the space within the determined one or more subsurface scenarios.

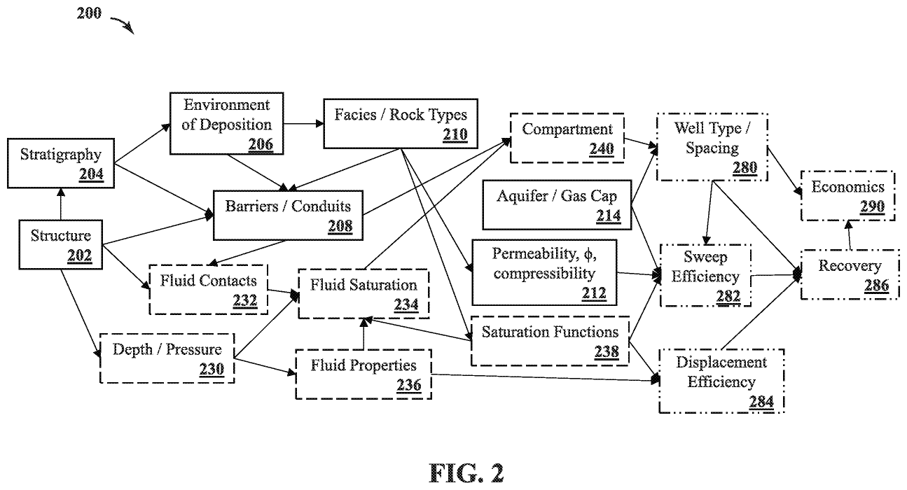

In some aspects, the parameter values can be determined independently and at random. In other aspects, the parameter values for at least one of the parameters can be determined in dependence on values selected for other parameters. For example, FIG. 2 shows sample dependencies of a selection of physical parameters of a representative geology. As shown in FIG. 2, each directed edge in the network of properties shows a dependency, with the arrowhead indicating the dependent property. In particular, FIG. 2 shows that stratigraphy is dependent on structure, that environment of deposition (EOD) is dependent on stratigraphy, that facies and rock types are dependent on EODs, and so on. One of skill in the art will recognize that additional parameters can be determined, and that additional (or different) dependencies can exist. In this way, the selection of the parameter values can maintain geologic plausibility.

Referring again to FIG. 1, the decision scenario discretizer 106 can define a decision space. The decision space can be defined by discretizing the decision space into a plurality of distinct decision scenarios. Discretizing the decision space can greatly reduce a number of decisions which must be contemplated, thus constraining the possible solution space and reducing the amount of modelling required to analyze the decision scenario. In some aspects, the distinct decision scenarios can be determined based on one or more development decisions to be made for development and collection of the subsurface resources. For example, the development decisions can comprise one or more of a determinations regarding use of an offshore platform or floating production storage and offloading (FPSO) facility, facility capacity and capabilities, number of wells, well placement, sequence of drilling, and other decisions related to development of the resource. Other example determinations can comprise production ramp-up pace, depletion mechanism, well type, well design, drilling radius, well costs, and the like.

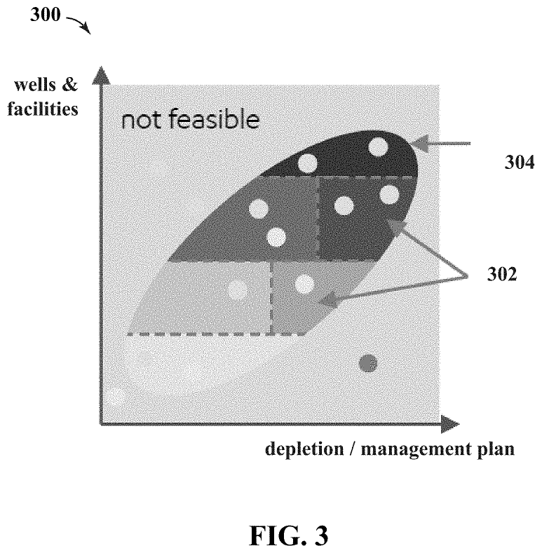

An example decision space 300 is shown in FIG. 3. The example decision space 300 shows a grouping of feasible decisions 302, where the grouping 302 has been discretized to represent a plurality of distinct decision scenarios 304. As shown in FIG. 3, the discretized decision space 300 represents a plurality of distinct decision scenarios 304 based on properties of the wells and facilities, as well as properties of the depletion management plan. While two properties are shown in FIG. 3 for simplicity of presentation, it will be clear to those of skill in the art that more or different properties can be used to define the distinct decision scenarios. As shown in FIG. 3, one of the distinct scenarios 304 is labeled “not feasible.” Such a scenario is a possible result when, for example, contractual limitations or regulations prevent resource collection in the way defined by the particular decision scenario.

Referring again to FIG. 1, the search processor 108 can be used to search the defined subsurface scenarios and couple the searched subsurface scenarios to a particular decision from within the defined decision space. The search processor 108 can select a first one of the subsurface scenarios as a first sample from the subsurface space. For the selected subsurface scenario, the search processor 108 can determine an optimal one of the discrete scenarios from the decision space associated with the selected subsurface scenario.

The search processor 108 can iteratively select one or more additional sample subsurface scenarios until a stopping criterion is satisfied. In some aspects, the stopping criterion can be related to the plurality of distinct decision scenarios. For example, the stopping criterion can comprise filling each of the finite number of discrete scenarios in the decision space. In other aspects, the stopping criteria can comprise a predetermined number of iterations without selecting a distinct discrete scenario from the decision space. The one or more additional subsurface scenarios can be selected randomly (e.g., via a Monte Carlo method) or pseudorandomly. Alternatively, each of the plurality of sample subsurface scenarios can be plotted in a multidimensional space, where each of a plurality of axes represents a particular parameter. The one or more additional subsurface scenarios can be selected based on a distance from one or more previously selected scenarios in the multidimensional space. Selecting the one or more additional subsurface scenarios based on the distance from the one or more previously selected scenarios helps to ensure that the full subsurface scenario space is covered by the selected sample subsurface scenarios in as few samples as possible.

The modeler 110 can assign risk and reward values to each of the sample subsurface scenarios. In some aspects, the risk and reward values can be determined by the modeler 110 based on the optimal one of the discrete decision scenarios selected from the decision space and the non-optimal ones of the discrete scenarios selected from the decision space. For example, the modeler 110 can model the output based on each of the discrete decision scenarios in the decision space to determine output and cost under each of the discrete decision scenarios. An average of the determined outputs under each of the discrete scenarios can be used to determine the risk and reward values. In some aspects, the average can be a weighted average.

Optionally, a respective likelihood (e.g., probability of occurrence) of each of the sample subsurface scenarios being accurate can be determined. The respective likelihoods can be determined via known elicitation techniques, such as the Delphi method, or any other known technique for determining likelihoods. The average of the determined outputs can be a weighted average based on the respective likelihoods.

In some aspects, the risk and reward values can be used to cause selection of a particular depletion plan. For example, the risk and reward values can be used to cause one or more oil wells to be drilled at one or more particular locations.

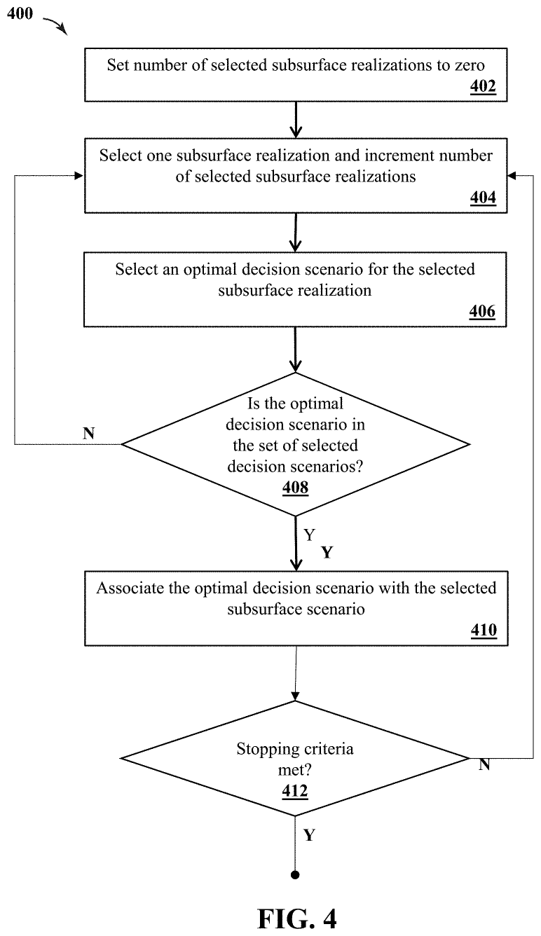

FIG. 4 shows a method 400 of sampling a subsurface scenario space to fully cover a decision scenario space. In the method 400, a subsurface scenario S comprising a plurality of samples s₁, s₂, s₃, . . . , sₙ can be defined. In some aspects, the samples can comprise one or more sample subsurface scenarios determined by determining parameter values for the one or more properties identified in the subsurface narrative. In some aspects, the parameter values can be determined to be either a discrete value or a range of values. The determined parameter values can be selected such that the plurality of samples enable a broad sampling of the space within the subsurface narrative S. Additionally, a decision scenario space D comprising discrete decision scenarios d₁, d₂, d₃, . . . , dₘ is defined. In this method, it is preferable that n>m. Those of skill in the art will recognize that, typically, this is a true statement, since there are a large number of unknown factors that make up a subsurface scenario, leading to an extremely large number of discrete subsurface samples. On the other hand, there are typically relatively few feasible discrete decision scenarios for a given reservoir.

Initially, at step 402, a number of selected subsurface realizations j is set to 0. At step 404, the number of selected sample subsurface realizations j is incremented, and a sample subsurface realization sⱼ is selected from the subsurface scenario S. The sample subsurface realization sⱼ can be selected randomly (e.g., via a Monte Carlo method) or pseudorandomly. Alternatively, each sample subsurface realization sⱼ can be plotted in a multidimensional space, where each of a plurality of axes represents a particular parameter. The sample subsurface realization can be selected based on a distance from one or more previously selected realizations. Selecting the sample subsurface realization sⱼ based on the distance from the one or more previously selected realizations helps to ensure that the full subsurface scenario space is covered by the selected sample subsurface realizations in as few samples as possible.

At step 406, an optimal decision scenario d is selected. In some aspects, the optimal decision scenario can be determined by modelling the sample subsurface realization based on each of the discrete decision scenarios and determining which discrete decision scenario generates the highest output. In other aspects, the optimal decision scenario can be selected based on other factors, such as minimizing capital costs, maximizing net profits, maximizing profit margin, and/or any other factors.

At step 408, it is determined if the selected optimal decision scenario d is within the set of decision scenarios associated with selected subsurface realizations. For example, it may be determined whether d is within the decision space D (e.g., is the optimal decision d enumerated in the set d₁, d₂, d₃, . . . , dₘ). If the selected optimal decision scenario d is not within the set of decision scenarios associated with the selected subsurface realizations (e.g., within the decision space D), the process 400 returns to step 402. If the optimal decision scenario d is within the set of decisions scenarios associated with the selected subsurface realizations (e.g., within the decision space D), the sample subsurface scenario sⱼ is associated with the decision scenario d at step 410.

At step 412, it is determined whether a stopping criterion has been satisfied. In some aspects, the stopping criterion can be related to the plurality of distinct decision scenarios. For example, the stopping criterion can comprise filling each of the finite number of discrete scenarios in the decision space (e.g., each of the discrete decision scenarios d₁, d₂, d₃, . . . , dₘ in D is associated with at least one subsurface scenario sⱼ). In other aspects, the stopping criteria can comprise a predetermined number of iterations without associating subsurface scenario with a new discrete scenario from the decision space. If the stopping criterion is not satisfied, the process 400 returns to step 402. If the stopping criterion is satisfied, the process 400 is complete. The selected sample subsurface scenarios selected during the process 400 comprise a sparse sampling of the decision space.

In some aspects, the sparse sampling of the decision space can be used to determine risk and reward for the discrete decision scenarios. Risk and reward values can be assigned to each of the decision scenarios. In some aspects, the risk and reward values can be determined by modeling each of the decision scenarios on each of the subsurface scenarios in the sparse sampling.

Optionally, a respective likelihood (e.g., probability of occurrence) of each of the sample subsurface scenarios being accurate can be determined. The respective likelihoods can be determined via known elicitation techniques, such as the Delphi method, or any other known technique for determining likelihoods. The average of the determined risk and reward values can be a weighted average based on the respective likelihoods.

In some aspects, the risk and reward values can be used to cause selection of a particular depletion plan. For example, the risk and reward values can be used to cause one or more oil wells to be drilled at one or more particular locations.

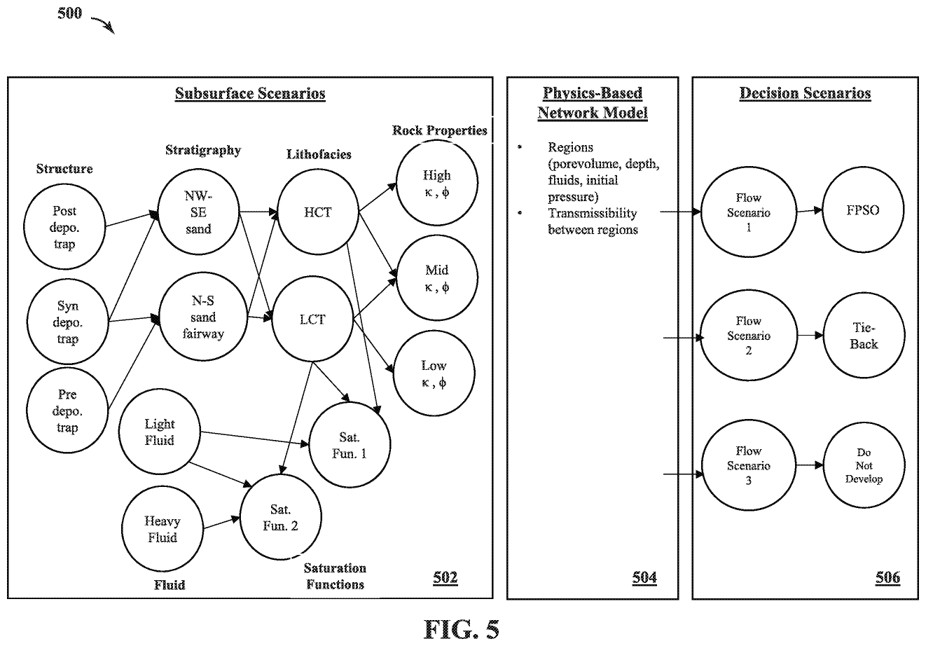

As a particular example, FIG. 5 shows a particular example decision model 500. In the decision model 500, a subsurface scenario generator 502 receives a subsurface scenario and generates a plurality of subsurface realizations. As shown in FIG. 5, the subsurface realizations include variations of parameters for structure (e.g., variations on fault timing, such as pre-, syn-, and post-deposition), stratigraphy (e.g., direction of sand), lithofacies (HCT or LCT), rock properties (e.g., values of K and ϕ), fluid (e.g., fluid weights), and saturation functions. In particular, the subsurface scenario generator 502 generates subsurface realizations having different values of these parameters.

The decision model 500 further includes a decision scenario discretizer 506 that has discretized the entire decision space into three categories: use of an FPSO facility, use of a Tie-Back, and a decision that development is too risky and should not be attempted.

A physics-based network model 504 can select a subsurface realization from the subsurface scenario generator 502 and model a flow scenario based on regions and transmissibility between regions. An optimal decision scenario from among the discrete scenarios created by the decision scenario discretizer 506 can be selected. For example, one of flow scenario 1, flow scenario 2, and flow scenario 3 can be selected. The network model 506 can continue to select subsurface scenarios at random until stopping criteria is satisfied. In the present example, the stopping criteria is satisfied once a subsurface scenario associated with each of the three discrete decision scenarios has been found.

Thereafter, the decision model 500 can assign risk and reward values to each of the decision scenarios. In some aspects, the risk and reward values can be determined by modeling each of the decision scenarios on each of the subsurface scenarios.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope. Other embodiments will be apparent to those skilled in the art from consideration of the specification and practice disclosed herein. It is intended that the specification and examples be considered as exemplary only, with a true scope being indicated by the following claims.

What is claimed is:

1. A method comprising:
defining a plurality of subsurface realizations from a given set of subsurface scenarios;
discretizing a decision space to determine a plurality of distinct decision scenarios;
sparsely sampling the subsurface realizations to determine a candidate subset of the plurality of subsurface realizations;
associating each of the candidate subset of the plurality of subsurface realizations with a respective one of the plurality of distinct decision scenarios; and
modelling each of the plurality of distinct decision scenarios based on each of the candidate subset of the plurality of subsurface realizations to determine risk and reward values for each of the plurality of distinct decision scenarios.

2. The method of claim 1, wherein sparsely sampling the subsurface realizations comprises:
selecting a candidate subsurface realization;
determining an optimal decision scenario associated with the candidate subsurface realization from among the plurality of distinct decision scenarios; and
iterating the selecting and determining steps until a stopping criteria is satisfied.

3. The method of claim 2, wherein the stopping criteria is related to the plurality of distinct decision scenarios.

4. The method of claim 2, wherein the stopping criteria comprises determining that at least one candidate subsurface realization is associated with each of the plurality of distinct decision scenarios.

5. The method of claim 2, wherein the stopping criteria comprises determining that a new one of the plurality of distinct decision scenarios has not been associated with a candidate subsurface realization within a predetermined number of iterations of the selecting and determining steps.

6. The method of claim 1, wherein determining the risk and reward values for each of the plurality of distinct decision scenarios comprises performing a computation based on the results of the modelling to assess risk and award.

7. The method of claim 6, further comprising assigning a probability to each subsurface scenario of the candidate subset of the plurality of subsurface scenarios.

8. The method of claim 6, wherein assessing the risk and reward may include both the modeling results and probabilities assigned to the scenarios.

9. The method of claim 6, wherein the computation comprises averaging the results of the modelling.

10. The method of claim 6, wherein the computation comprises computing a weighted average based on assigned probabilities.

11. An apparatus, comprising:
one or more processors; and
a memory having embodied thereon processor executable instructions that, when executed by the one or more processors, cause the apparatus to:
define a plurality of subsurface realizations;
discretize a decision space to determine a plurality of distinct decision scenarios;
sparsely sample the subsurface realizations to determine a candidate subset of the plurality of subsurface realizations;
associate each of the candidate subset of the plurality of subsurface realizations with a respective one of the plurality of distinct decision scenarios; and
model each of the plurality of distinct decision scenarios based on each of the candidate subset of the plurality of subsurface realizations to determine risk and reward values for each of the plurality of distinct decision scenarios.

12. The apparatus of claim 11, wherein the processor executable instructions that, when executed by the one or more processors, cause the apparatus sparsely sampling the subsurface realizations, comprises causing the processor to:
select a candidate subsurface realization;
determine an optimal decision scenario associated with the candidate subsurface realization from among the plurality of distinct decision scenarios; and
iterate the selecting and determining steps until a stopping criteria is satisfied.

13. The apparatus of claim 12, wherein the stopping criteria is related to the plurality of distinct decision scenarios.

14. The apparatus of claim 12, wherein stopping criteria comprises determining that at least one candidate subsurface realization is associated with each of the plurality of distinct decision scenarios.

15. The apparatus of claim 12, wherein stopping criteria comprises determining that a new one of the plurality of distinct decision scenarios has not been associated with a candidate subsurface realization within a predetermined number of iterations of the selecting and determining steps.

16. The apparatus of claim 11, wherein the processor executable instructions, when executed by the one or more processors, cause the apparatus to determine the risk and reward values for each of the plurality of distinct decision scenarios, comprises causing the apparatus to performing a computation based on the results of the modelling to assess risk and award.

17. The apparatus of claim 16, wherein the processor executable instructions, when executed by the one or more processors, further cause the apparatus to assign a probability to each subsurface scenario of the candidate subset of the plurality of subsurface scenarios.

18. The apparatus of claim 16, wherein computation comprises both the modeling results and probabilities assigned to the scenarios.

19. An apparatus comprising:
a subsurface realization generator configured to define a plurality of subsurface realizations;
a decision scenario discretizer configured to discretize a decision space to determine a plurality of distinct decision scenarios;
a search processor configured to sparsely sample the subsurface realizations to determine a candidate subset of the plurality of subsurface realizations and associate each of the candidate subset of the plurality of subsurface realizations with a respective one of the plurality of distinct decision scenarios; and
a modeler configured to model each of the plurality of distinct decision scenarios based on each of the candidate subset of the plurality of subsurface realization to determine risk and reward values for each of the plurality of distinct decision scenarios.

20. The apparatus of claim 19, wherein the search processor is configured to:
select a candidate subsurface realization;
determine an optimal decision scenario associated with the candidate subsurface realization from among the plurality of distinct decision scenarios; and
iterate the selecting and determining steps until a stopping criteria is satisfied.

21. The apparatus of claim 20, wherein stopping criteria comprises determining that at least one candidate subsurface scenario is associated with each of the plurality of distinct decision scenarios.

22. The apparatus of claim 19, wherein the modeler is configured to determine the risk and reward values for each of the plurality of distinct decision scenarios by averaging results of the modelling.
